(19) United States
(12) Patent Application Publication
(10) Pub. No.: US 2016/0134553 A1
(43) Pub. Date: May 12, 2016

(54) FLEXIBLE SCHEDULING METHOD AND APPARATUS IN LIN COMMUNICATION

(71) Applicants: HYUNDAI MOTOR COMPANY, Seoul (KR); KIA MOTORS CORPORATION, Seoul (KR)

(72) Inventor: Soo Yun KIM, Incheon (KR)

(21) Appl. No.: 14/748,016

(22) Filed: Jun. 23, 2015

(30) Foreign Application Priority Data
Nov. 12, 2014 (KR) 10-2014-0157075

(51) Int. Cl. H04L 12/865; H04L 12/26

(52) U.S. Cl. CPC H04L 47/6275; H04L 43/0811; H04L 2012/40234

(57) ABSTRACT

A flexible scheduling method in local interconnection network (LIN) communication includes performing a broadcasting procedure using a predetermined LIN scheduling table when the LIN bus is activated, checking whether a slave node is connected to the LIN bus through the broadcasting procedure, re-configuring the LIN scheduling table using information about the slave node, connection of which is checked, and performing message scheduling using the re-configured LIN scheduling table. Thus, it is advantageous of enabling flexible scheduling in LIN communication.

### CROSS-REFERENCE TO RELATED APPLICATION

This application claims the benefit of Korean Patent Application No. 10-2014-0157075, filed on Nov. 12, 2014, which is hereby incorporated by reference as if fully set forth herein.

### BACKGROUND OF THE INVENTION

1. Field of the Invention

The present invention relates to a flexible scheduling method and apparatus in local interconnection network (LIN) communication, and more particularly, to a flexible scheduling method and apparatus in a LIN communication network for enabling plug and play of a slave node using LIN communication.

2. Discussion of the Related Art

A vehicle, e.g., a car, a truck, a bus, an agricultural vehicle, an airplane, etc., includes a vehicle communication network. The complexity of the vehicle communication network is rapidly increasing as the type of electrical devices in a vehicle is diversified and the number of electrical devices is increased. For example, many enhanced vehicles include engine control, transmission control, antilock braking, body control, emissions control, automatic indoor temperature control, automatic illumination control, automatic mirror control, and so on.

In order to support various electrical devices in a vehicle, an automobile industry has generated numerous communication protocols.

As vehicle technology has developed, recently introduced vehicles have provided more diversified and complex measurement and sensing functions. The sensing functions can be provided by an electrical control apparatus of a car, that is, an electronic control unit (ECU).

In particular, according to continuous demands for high-class cars, consumer safety and convenience, more electrical devices are mounted on a vehicle, and thus a communication network becomes very important for information exchange and sharing between electrical devices. Conventionally, communication between a vehicle control system and sensors is mainly achieved in a point-to-point manner, and thus many problems arise in terms of price, production time, reliability, etc.

Accordingly, recently introduced vehicles have provided various bus protocols, and at least one gateway for a vehicle has been introduced in order to support communication between electrical devices using different bus protocols.

Local interconnection network (LIN) communication as a network communication method in a vehicle is mainly used for data transmission between an ECU, an active sensor, and an active actuator.

LIN communication may include a master node that requests data or transmits a control command and slave nodes that collect and answer data corresponding to the data request from the master node or perform an operation corresponding to the control command received from the master node.

Conventionally, a method for checking slave nodes connected to a LIN bus in LIN communication is largely classified into a prefixed scheduling method and a diagnostic frame method.

In the prefixed scheduling method, a LIN scheduling table of slave nodes included in a LIN bus is pre-configured via software so as to check the slave nodes. In a hardware option processing method as the prefixed scheduling method, hardware option is configured via software so as to unify software via a method for generating a LIN scheduling table. However, as hardware specifications are increased, option setting becomes more complex and a LIN scheduling table for each hardware option needs to be configured.

In the diagnostic frame method, when a master node transmits a diagnosis frame to a slave node, the slave node transmits information about configuration of the slave node in response to the diagnosis frame, and thus the master node checks whether the corresponding node is normally connected to the LIN bus so as to configure LIN scheduling information.

In particular, in the prefixed scheduling method, according to a vehicle power condition, e.g., VBATT, ignition, ACC, alternator ON, etc., a plurality of LIN scheduling tables needs to be configured and a corresponding LIN scheduling table is changed and used as the vehicle power condition is changed.

In addition, when a LIN bus is physically separately designed, it is necessary to group slave nodes according to the vehicle power condition and to configure physically independent LIN bus lines for each respective group.

However, when the LIN bus is physically separately designed, LIN bus wiring cost is disadvantageously increased.

The prefixed scheduling method is disadvantageous in that a LIN scheduling table for all slave nodes connected to a LIN bus needs to be pre-configured and a master node needs to also be changed when a new slave node is added or deleted to and from the LIN, and thus system commonality is difficult.

Since a diagnosis frame used in the diagnostic frame method is not a signal-based message defined in the standard, processing delay may be caused in the slave node, and thus a specific event that occurs in a vehicle, e.g., a vehicle collision detection event, etc. due to air bag unfolding, may be lost.

In addition, in the diagnostic frame method, when slave nodes for controlling a vehicle sheet operate in conjunction with each other to completely perform one operation, e.g., relax, return operations, etc. of a vehicle sheet, if event loss due to communication delay occurs, processing delay corresponding to the event loss may occur.

### SUMMARY OF THE INVENTION

Accordingly, the present invention is directed to a flexible scheduling method and apparatus in local interconnection network (LIN) communication that substantially obviates one or more problems due to limitations and disadvantages of the related art.

An object of the present invention is to provide a flexible scheduling method and apparatus in LIN communication.

Another object of the present invention is to provide a flexible scheduling method and apparatus in LIN communication, for dynamic configuration of a LIN scheduling table using a signal defined in the LIN communication standard.

Another object of the present invention is to provide a flexible scheduling method and apparatus in LIN communication, for flexibly re-configuring a LIN scheduling table when a power condition is changed.

A further object of the present invention is to provide a flexible scheduling method and apparatus in LIN communication, for flexibly re-configuring a LIN scheduling table when a system configuration is changed.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a flexible scheduling method and apparatus in LIN communication is provided.

In an aspect of the present invention, a method for controlling scheduling in a master node connected to a local interconnection network (LIN) bus includes performing a broadcasting procedure using a predetermined LIN scheduling table when the LIN bus is activated, checking whether a slave node is connected to the LIN bus through the broadcasting procedure, re-configuring the LIN scheduling table using information about the slave node, connection of which is checked, and performing message scheduling using the re-configured LIN scheduling table.

Here, the method may further include detecting a scheduling update event during the message scheduling, and re-configuring the LIN scheduling table according to detection of the scheduling update event.

In this case, the scheduling update event may be detected when communication with the salve node, connection of which is checked, is not possible, and scheduling information about the slave node with which communication is not possible may be deleted from the LIN scheduling table.

The scheduling update event may be detected when a vehicle power condition is changed.

The broadcasting procedure may include transmitting a message header to all slave nodes connectable to the LIN bus, and checking a connection state of the slave node according to whether a message response corresponding to the message header is received.

The broadcasting procedure may be repeatedly performed a predetermined number of times.

The broadcasting procedure may be periodically performed during the message scheduling.

Here, when the message scheduling is started, a broadcasting timer may be driven for a predetermined period of time, and the broadcasting procedure may be performed when the driven broadcasting timer expires.

The method may further include receiving a broadcasting request message from an external device connected through a predetermined connection terminal of the master node, wherein the broadcasting procedure may be performed when the broadcasting request message is received.

In another aspect of the present invention, a method for controlling scheduling in a master node connected to a local interconnection network (LIN) bus includes transitioning an idle state to a broadcasting state when the LIN bus is activated in the idle state, in the broadcasting state, broadcasting a message header to all slave nodes connectable to the LIN bus and then performing a broadcasting procedure for checking connection of a slave node based on whether a message response corresponding to the message header is received, and when the broadcasting procedure is completed, transitioning the broadcasting state to a scheduling communication state and performing message scheduling on the slave node, connection of which is checked.

Upon transitioning to the scheduling communication state, a predetermined broadcasting timer may be driven, and when the broadcasting timer expires, the scheduling communication state may be transitioned to the broadcasting state and the broadcasting procedure may be performed.

Upon detection of change in a vehicle power condition in the scheduling communication state, the scheduling communication state may be transitioned to the broadcasting state and the broadcasting procedure may be performed.

Upon detection of a slave node with which communication is not possible in the scheduling communication state, the scheduling communication state may be transitioned to the broadcasting state and the broadcasting procedure may be performed.

The method may further include re-configuring a LIN scheduling table using the slave node, connection of which is checked via the broadcasting procedure, wherein the message scheduling may be performed using the re-configured LIN scheduling table.

Upon reception of a broadcasting request message from an external device in the scheduling communication state, the scheduling communication state may be transitioned to the broadcasting state and the broadcasting procedure may be performed.

In another aspect of the present invention, a non-transitory computer readable recording medium having recorded thereon a program for executing any one of the above scheduling controlling method is provided.

In another aspect of the present invention, an apparatus for controlling scheduling for local interconnection network (LIN) includes a LIN communication unit for performing a broadcasting procedure using a predetermined LIN scheduling table when the LIN bus is activated and checking a slave node connected to the LIN bus, a LIN scheduling table update unit for re-configuring the LIN scheduling table using information about the slave node, connection of which is checked, and a controller for performing message scheduling using the re-configured LIN scheduling table.

The method may further include a scheduling update event detector for detecting a scheduling update event during the message scheduling, wherein the LIN scheduling table may be re-configured according to detection of the scheduling update event.

The scheduling update event may be detected when communication with the salve node, connection of which is checked, is not possible, and scheduling information about the slave node with which communication is not possible may be deleted from the LIN scheduling table.

The scheduling update event may be detected when a vehicle power condition is changed.

The LIN communication unit may transmit a message header to all slave nodes connectable to the LIN bus and perform the broadcasting procedure for checking a connection state of the slave node according to whether a message response corresponding to the message header is received.

Here, the LIN communication unit may repeatedly perform the broadcasting procedure a predetermined number of times.

The broadcasting procedure may be periodically performed during the message scheduling.

The apparatus may further include an external interface unit for communication with an external device, wherein the controller may control to perform the broadcasting procedure when a predetermined broadcasting request message is received from the external device during the message scheduling.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram illustrating a configuration of a message header in local interconnection network (LIN) communication;

FIG. 2 is a diagram illustrating a configuration of a message response in LIN communication;

FIG. 3 is a state transition diagram for explanation of an operation of a master node in LIN communication;

FIG. 4 is a state transition diagram for explanation of an operation of a slave node in LIN communication;

FIG. 5 is a flowchart for explanation of a method of controlling scheduling in a master node according to an embodiment of the present invention;

FIG. 6 is a flowchart for explanation of a method of controlling scheduling in LIN communication according to an embodiment of the present invention;

FIG. 7 is a state transition diagram for explanation of a method of controlling scheduling in LIN communication according to an embodiment of the present invention; and

FIG. 8 is a diagram illustrating a configuration of a LIN communication system according to an embodiment of the present invention.

### DETAILED DESCRIPTION OF THE INVENTION

Reference will now be made in detail to the preferred embodiments of the present invention, examples of which are illustrated in the accompanying drawings. The suffixes “module” and “unit” of elements herein are used for convenience of description and thus can be used interchangeably and do not have any distinguishable meanings or functions.

Although all elements constituting the embodiments of the present invention are described as integrated into a single one or to be operated as a single one, the present invention is not necessarily limited to such embodiments. According to embodiments, all of the elements may be selectively integrated into one or more and be operated as one or more within the object and the scope of the present invention. Each of the elements may be implemented as independent hardware. Alternatively, some or all of the elements may be selectively combined into a computer program having a program module performing some or all functions combined in one or more pieces of hardware. A plurality of codes and code segments constituting the computer program may be easily understood by those skilled in the art to which the present invention pertains. The computer program may be stored in non-transitory computer readable media such that the computer program is read and executed by a computer to implement embodiments of the present invention. Computer program storage media may include magnetic recording media, optical recording media, and carrier wave media.

The term “comprises”, “includes”, or “has” described herein should be interpreted not to exclude other elements but to further include such other elements since the corresponding elements may be included unless mentioned otherwise. All terms including technical or scientific terms have the same meanings as generally understood by a person having ordinary skill in the art to which the present invention pertains unless mentioned otherwise. Generally used terms, such as terms defined in a dictionary, should be interpreted to coincide with meanings of the related art from the context. Unless differently defined in the present invention, such terms should not be interpreted in an ideal or excessively formal manner.

It will be understood that, although the terms first, second, A, B, (a), (b), etc. may be used herein to describe various elements of the present invention, these terms are only used to distinguish one element from another element and essential, order, or sequence of corresponding elements are not limited by these terms. It will be understood that when one element is referred to as being “connected to”, “coupled to”, or “access” another element, one element may be “connected to”, “coupled to”, or “access” another element via a further element although one element may be directly connected to or directly access another element.

In general, a LIN communication network includes one master node and one or more slave nodes, e.g., the number of slave nodes connected to a LIN bus may be 2 to 16. All nodes include one slave communication operation divided into one transmission operation and one reception operation, and on the other hand, the master node includes all additional master transmission operations.

In LIN communication, a master node controls overall bus and protocol, schedules a time point at which a message is transmitted to a bus, and performs an error processing function.

The master node may transmit a message header including sync break, sync byte, a message identifier (ID), or a protect identifier (PID) and monitor check bytes and data bytes transmitted by the slave node.

In addition, the master node may transmit data to the slave node after transmitting the message header.

The slave node may transmit a message response to the message header received from the master node to the master node. In addition, the slave node may transmit a message response to the message header received from the master node to another slave node.

The master node generates a message header called Token on a LIN bus at a specific time point and transmits the message header to the LIN bus. The message header may be used for synchronization between nodes in LIN communication. To this end, the master node needs to maintain a reference counter for providing accurate reference time information to nodes connected to the LIN bus and the slave node does not have to include a separate synchronization timer.

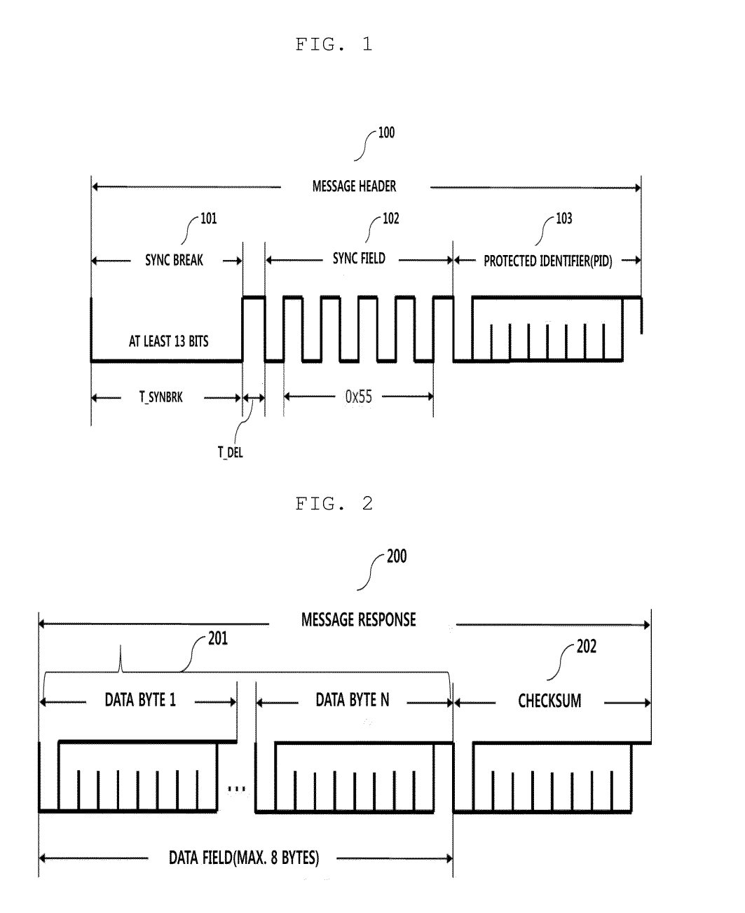

FIG. 1 is a diagram illustrating a configuration of a message header 100 in LIN communication.

Referring to FIG. 1, the message header 100 includes a Sync Break 101 field having a length of at least bits for frame synchronization in LIN communication, a Sync field 102 for transmitting reference visual information required for synchronization, and a protected identifier (PID) 103 for identifying a message type.

The PID 103 field includes a message address having a length of 8 bits and 2-bit parity bits for protection of an important message address. Slave nodes may analyze a message header and send data corresponding to the message address (which corresponds to SEND), may receive data and perform a specific operation (which corresponds to RECEIVE), or may not perform any operation (may ignore the message response).

A slave task may be activated in the master node. In this case, it is noted that the slave task of the mater node may also collect data and transmit the data on a LIN bus after transmission of the message header 100.

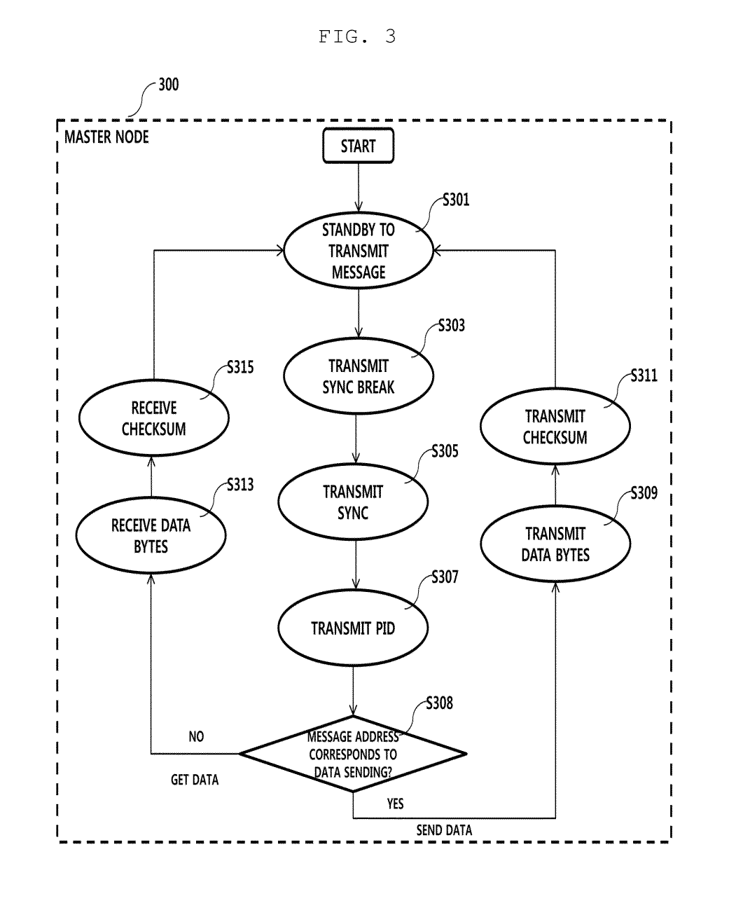

FIG. 2 is a diagram illustrating a configuration of a message response 200 in LIN communication.

Referring to FIG. 2, the message response 200 includes first to n^{th} data bytes 201 fields with 8 bits as a maximum length and a checksum 202 field.

The message response 200 may be transmitted by a slave node, the data bytes 201 fields may be used to transmit data collected by a slave node according to the message address contained in the PID 103 field, and the checksum 202 field may be used to check integrity with respect to the data bytes 201 in the master node and configured via calculation of Modulo-2 and Carry Bit for all of the data bytes 201.

In this case, byte transmission of data contained in the data bytes 201 field may be performed from a least significant bit (LSB) and word transmission may be performed from a low byte (Little Endian Transmission).

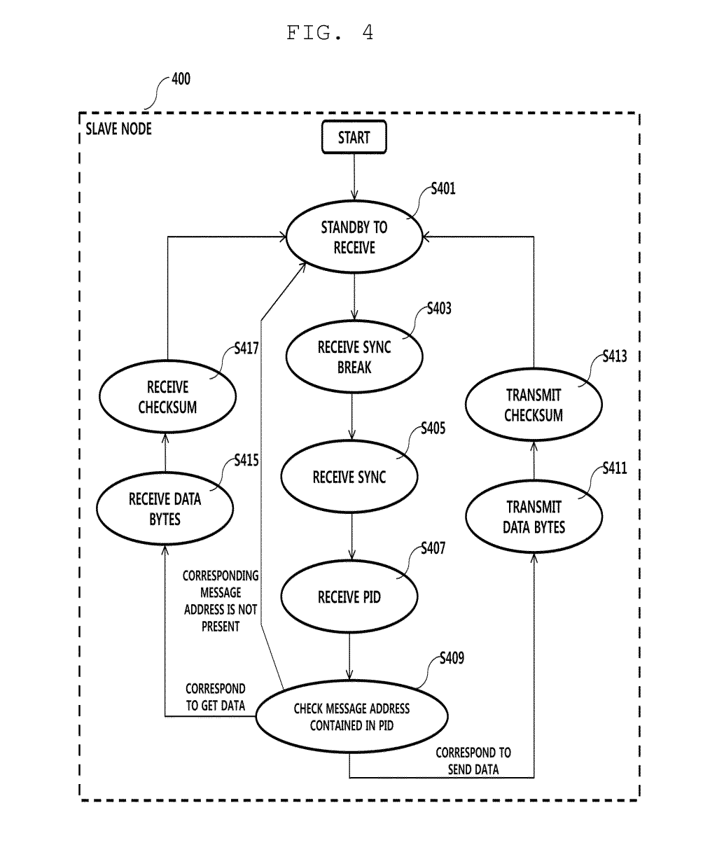

FIG. 3 is a state transition diagram for explanation of an operation of a master node 300 in LIN communication.

Referring to FIG. 3, the master node 300 is on standby to transmit a message based on internal LIN scheduling information (S301). Continuously, the master node 300 may sequentially transmit the Sync Break 101, the Sync 102, and the PID 103, i.e., transmit the message header 100 and check whether the message address contained in the PID 103 field corresponds to data sending (which corresponds to SEND DATA in FIG. 3) (S303 to S308).

As the checked result, when the message address is associated with SEND DATA, the slave task of the master node 300 transmits the data bytes 201 and the checksum 202 corresponding to the message address on a LIN bus (S309 to S311). Then, the master node 300 returns to the aforementioned operation S301.

On the other hand, as the checked result, when the message address is associated with GET DATA, the master node 300 receives the data bytes 201 and the checksum 202 on the LIN bus (S313 to S315). Then the master node 300 returns to the aforementioned operation S301.

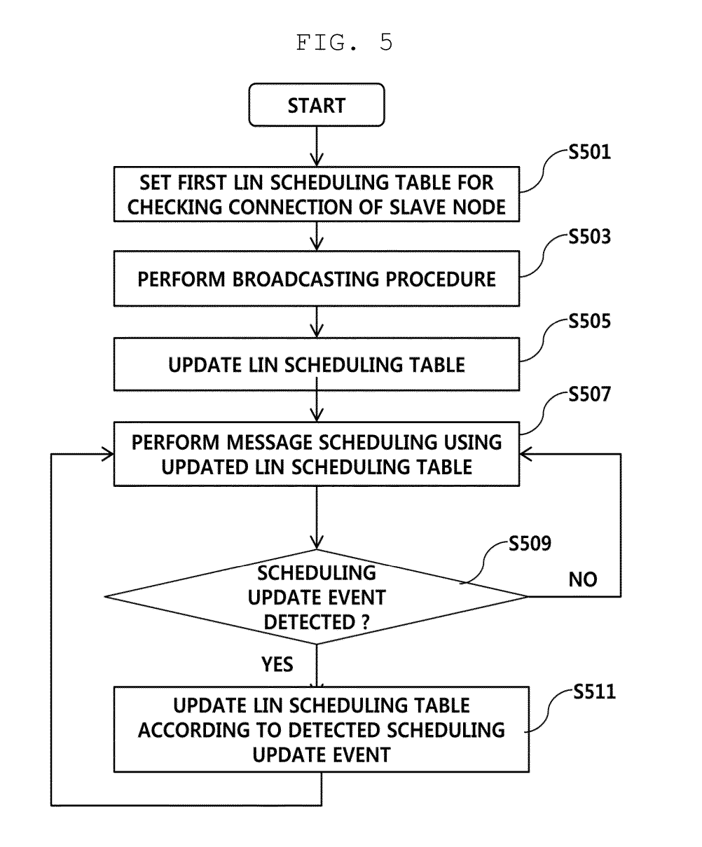

FIG. 4 is a state transition diagram for explanation of an operation of a slave node 400 in LIN communication.

Referring to FIG. 4, when the slave node 400 is on standby to receive a message (S401), the slave node 400 may sequentially receive the Sync Break 101, the Sync 102, and the PID 103 that are transmitted by the master node 300, i.e., receive the message header 100 (S403 to S407).

Continuously, the slave node 400 checks a type of the message address contained in the PID 103 field with reference to an internal message address table (S409).

As the checked result, when the message address type corresponds to message transmitting (which corresponds to SEND DATA in FIG. 4), the slave node 400 transmits the data bytes 201 and the checksum 202 corresponding to the message address on the LIN bus (S411 to S413). Then the slave node 400 returns to the aforementioned operation S401.

When the received message address is not present in the internal message address table, the slave node 400 ignores the received PID 103 field and performs transition to the reception standby state S401.

Thus, the slave node 400 may add internal collected data to the message response 200 and transmit the message response 200, may receive data on a LIN bus and perform a specific operation, or may not perform any operation according to the received message address type.

As the checked result, when the message address type corresponds to message receiving (which corresponds to GET DATA in FIG. 4), the slave node 400 receives the data bytes 201 and the checksum 202 corresponding to the message address on the LIN bus (S415 to S417). Then the slave node 400 returns to the aforementioned operation S401.

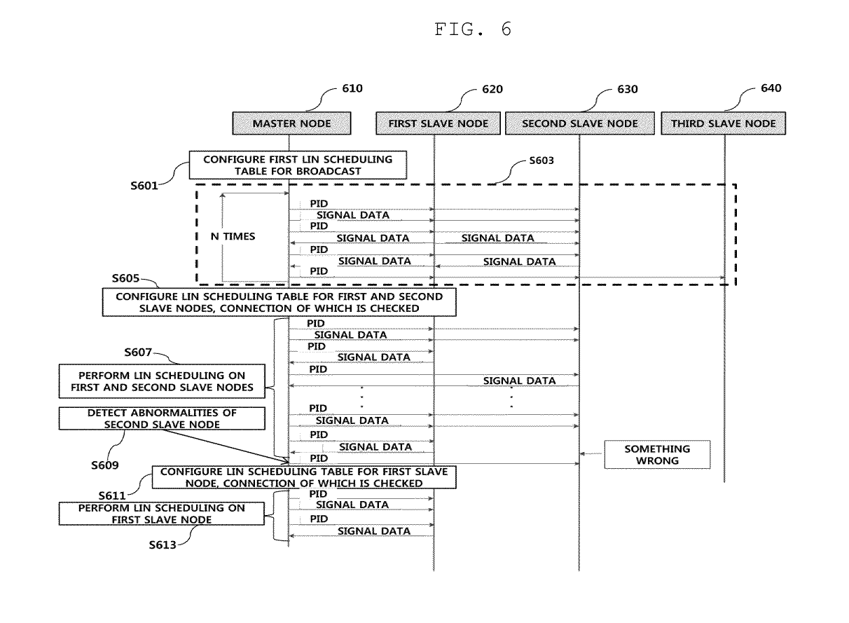

FIG. 5 is a flowchart for explanation of a method of controlling scheduling in a master node according to an embodiment of the present invention.

Referring to FIG. 5, when a first LIN scheduling table to be used in a broadcasting procedure for checking a slave node connected to a LIN bus is configured, the master node 300 initiates the broadcasting procedure with reference to the first LIN scheduling table (S501 to S503).

The master node 300 re-configures a LIN scheduling table for the slave nodes, connection of which is checked, via the broadcasting procedure and performs message scheduling based on the re-configured LIN scheduling table (S505 to S507).

Upon detecting a scheduling update event, the master node 300 re-configures the LIN scheduling table based on the detected scheduling update event (S509 to S511). Continuously, the master node 300 may return to the aforementioned operation S509 and perform message scheduling using the re-configured LIN scheduling table.

For example, the scheduling update event may be detected when a slave node that is pre-connected on the LIN bus or a vehicle start condition is changed.

In addition, the master node 300 may perform a broadcasting procedure according to a predetermined period. Upon detecting that a new slave is connected on the LIN bus via the period broadcasting procedure, the master node 300 may re-configure a LIN scheduling table in which the newly added slave node is reflected.

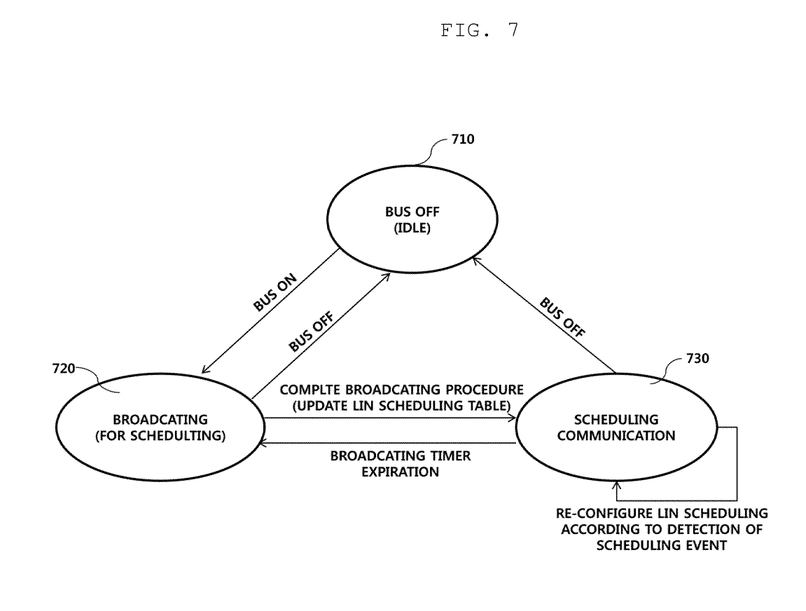

FIG. 6 is a flowchart for explanation of a method of controlling scheduling in LIN communication according to an embodiment of the present invention.

Referring to FIG. 6, when a first LIN scheduling table for broadcasting is configured, a master node 610 may perform a broadcasting procedure a predetermined number of times (S601 to S603). Here, in the broadcasting procedure, the master node 610 may transmit a message header containing a specific PID to all slave nodes 620 to 640 that can be connected to a LIN bus and a LIN bus connection state of a slave node may be checked according to whether a message response (SIGNAL DATA) corresponding to the corresponding PID is received.

Upon checking the slave node(s) connected to the LIN bus via the broadcasting procedure the predetermined number of times, the master node 610 may re-configure the LIN scheduling table for the slave nodes, connection of which is checked (S605). FIG. 6 illustrates that connection of a first slave node 620 and a second slave node 630 is checked, that is, the first slave node 620 and the second slave node 630 are activated.

Then the master node 610 may perform message scheduling on the first slave node 620 and the second slave node 630, connection of which is checked, based on the LIN scheduling table re-configured in the above operation 605 (S607).

As illustrated in FIG. 6, upon detecting abnormalities of the second slave node 630 during the message scheduling, the master node 610 may re-configure the LIN scheduling table containing message scheduling information only for the first slave node 620 (S609 to S611).

Then the master node 610 may perform message scheduling on the first slave node 620 using the re-configured LIN scheduling table (S613).

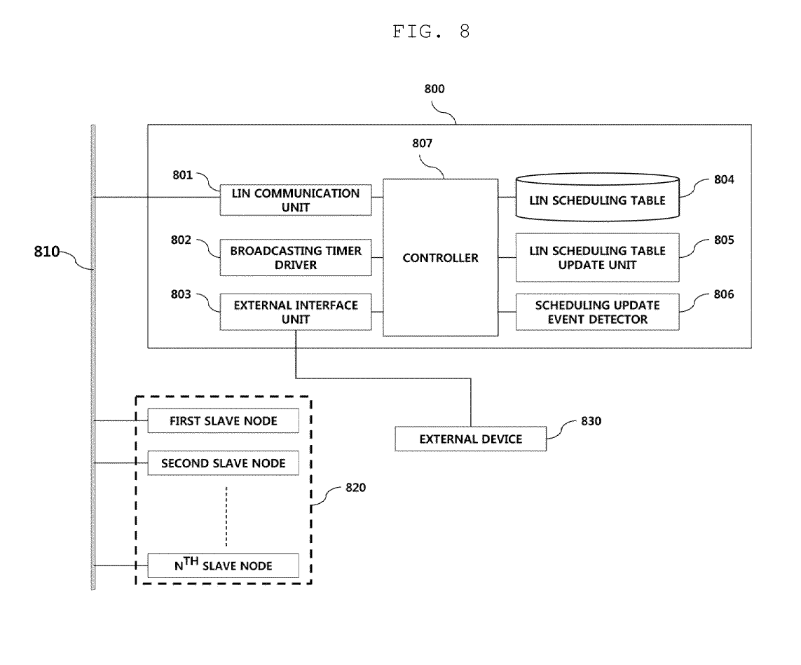

FIG. 7 is a state transition diagram for explanation of a method of controlling scheduling in LIN communication according to an embodiment of the present invention.

Referring to FIG. 7, a LIN scheduling state may include an idle state 710, a broadcasting state 720, and a scheduling communication state 730.

In the idle state 710, a LIN bus may be deactivated, i.e., a BUS OFF state or a vehicle may not be started.

In the idle state 710, when the LIN bus is activated (BUS ON), the LIN scheduling state is transitioned to the broadcasting state 720. In the broadcasting state 720, the master node 300 may check the slave node(s) connected to the LIN bus with reference to a pre-configured LIN scheduling table.

In the broadcasting state 720, when the LIN scheduling state for the slave node(s), connection of which is checked, is re-configured, i.e., when a broadcasting procedure is completed, a LIN scheduling state is transitioned to a scheduling communication state 730.

In the scheduling communication state 730, the master node 300 performs message scheduling using the re-configured LIN scheduling table.

Upon detecting a scheduling update event in the scheduling communication state 730, the master node 300 may re-configure a LIN scheduling table according to the detected scheduling update event.

Here, the scheduling update event may be detected when a response from the slave node connected on the LIN bus is not present or a vehicle power condition is changed.

For example, the vehicle power condition may be changed to an Ignition OFF state from an Ignition ON state, changed to an ACC OFF state from an ACC ON state, or changed to an Alternator OFF state from an Alternator ON state. In general, a type of an operable controller may be changed according to a vehicle power condition, and accordingly a LIN scheduling table needs to also be re-configured according to a corresponding vehicle power condition.

In addition, in the broadcasting state 720, when the vehicle power condition may be transitioned to the scheduling communication state 730, a broadcasting timer may be driven at a predetermined period. In this case, when the driven broadcasting timer expires, the LIN scheduling state may be transitioned to the broadcasting state 720 from the scheduling communication state 730.

As another example, upon detecting a slave node with which communication is not possible in the scheduling communication state 730, the scheduling communication state 730 may be transitioned to the broadcasting state 720. In this case, the slave node with which communication is not possible may be excluded from a scheduling target via the broadcasting procedure.

As another example, when a new slave node is additionally configured on a LIN bus, a user may control to manually perform a broadcasting procedure through a user interface.

For example, the user may connect an external device to a predetermined connection terminal included in the master node and transmit a predetermined control signal to the master node using predetermined software installed in the external device so as to initiate the broadcasting procedure.

FIG. 8 is a diagram illustrating a configuration of a LIN communication system according to an embodiment of the present invention.

Referring to FIG. 8, the LIN communication system may include a master node 800 and first to n^{th} slave nodes 820 connected via a LIN bus 810.

The master node 800 may include a LIN communication unit 801, a broadcasting timer driver 802, an external interface unit 803, a LIN scheduling table 804, a LIN scheduling table update unit 805, a scheduling update event detector 806, a controller 807, etc.

The LIN communication unit 801 provides LIN communication with the first to n^{th} slave nodes 820 via the LIN bus 810. In particular, the LIN communication unit 801 may perform a broadcasting procedure for checking the slave nodes 820 connected to the LIN bus 810 according to a predetermined control signal of the controller 807 and transmit information about the slave nodes 820, connection of which is checked via the broadcasting procedure, to the controller 807.

When the broadcasting state 720 is transitioned to the scheduling communication state 730, the broadcasting timer driver 802 may drive a broadcasting timer according to the control signal of the controller 807 and transmit a predetermined timer expiration control signal to the controller 807 when the driven broadcasting timer expires. In this case, the controller 807 may control to transition the scheduling communication state 730 to the broadcasting state 720 and to perform the broadcasting procedure.

The external interface unit 803 may provide a connection unit with an external device 830, and a user may connect the external device 830 to the external interface unit 803 and then control to transmit a predetermined broadcasting request signal (or message) for compulsorily performing the broadcasting procedure via predetermined menu selection on the external device 830 to the master node 800. In this case, the master node 800 may initiate the broadcasting procedure according to the broadcasting request signal.

The LIN scheduling table update unit 805 may receive information about a slave node, connection of which is checked via the broadcasting procedure, from the controller 807 and re-configure the LIN scheduling table 804.

When a scheduling update event such as checking of a slave node with which communication is not possible, change in vehicle power condition, etc. occurs during message scheduling, the scheduling update event detector 806 may transmit information indicating that the corresponding event occurs, to the controller 807. Thus, the controller 807 may request the LIN scheduling table update unit 805 for a predetermined control signal so as to update the LIN scheduling table 804 according to the received scheduling update event.

As is apparent from the above description, the method and apparatus according to the present invention have the following effects.

First, the present invention has an advantage of providing a flexible scheduling method and apparatus in LIN communication.

Second, the present invention has an advantage of providing a flexible scheduling method and apparatus in LIN communication, for dynamic configuration of a LIN scheduling table using a signal defined in the LIN communication standard.

Third, the present invention has an advantage of providing a flexible scheduling method and apparatus in LIN communication, for flexibly re-configuring a LIN scheduling table when a power condition is changed.

Fourth, the present invention has an advantage of providing a plug and play function of a controller and standardization of components of the controller by flexibly re-configuring a LIN scheduling table according to change in system configuration.

Fifth, the present invention has an advantage of providing reduction in wiring costs by preventing separate design of physical LIN buses for respective vehicle power conditions.

Sixth, the present invention has an advantage of minimizing control period information loss.

Seventh, the present invention has an advantage of reducing software and hardware maintenance costs according to common software for each vehicle system specification.

It will be appreciated by persons skilled in the art that that the effects that can be achieved through the present invention are not limited to what has been particularly described hereinabove and other advantages of the present invention will be more clearly understood from the above detailed description.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method for controlling scheduling in a master node connected to a local interconnection network (LIN) bus, the method comprising:
performing a broadcasting procedure using a predetermined LIN scheduling table when the LIN bus is activated;
checking whether a slave node is connected to the LIN bus through the broadcasting procedure;
re-configuring the LIN scheduling table using information about the slave node, connection of which is checked; and
performing message scheduling using the re-configured LIN scheduling table.

2. The method according to claim 1, further comprising:
detecting a scheduling update event during the message scheduling; and
re-configuring the LIN scheduling table according to detection of the scheduling update event.

3. The method according to claim 2, wherein:
the scheduling update event is detected when communication with the salve node, connection of which is checked, is not possible; and
scheduling information about the slave node with which communication is not possible is deleted from the LIN scheduling table.

4. The method according to claim 2, wherein the scheduling update event is detected when a vehicle power condition is changed.

5. The method according to claim 1, wherein the broadcasting procedure comprises:
transmitting a message header to all slave nodes connectable to the LIN bus; and
checking a connection state of the slave node according to whether a message response corresponding to the message header is received.

6. The method according to claim 5, wherein the broadcasting procedure is repeatedly performed a predetermined number of times.

7. The method according to claim 6, wherein the broadcasting procedure is periodically performed during the message scheduling.

8. The method according to claim 7, wherein:
when the message scheduling is started, a broadcasting timer is driven for a predetermined period of time; and
the broadcasting procedure is performed when the driven broadcasting timer expires.

9. The method according to claim 1, further comprising receiving a broadcasting request message from an external device connected through a predetermined connection terminal of the master node,
wherein the broadcasting procedure is performed when the broadcasting request message is received.

10. A method for controlling scheduling in a master node connected to a local interconnection network (LIN) bus, the method comprising:
transitioning an idle state to a broadcasting state when the LIN bus is activated in the idle state;
in the broadcasting state, broadcasting a message header to all slave nodes connectable to the LIN bus and then performing a broadcasting procedure for checking connection of a slave node based on whether a message response corresponding to the message header is received; and
when the broadcasting procedure is completed, transitioning the broadcasting state to a scheduling communication state and performing message scheduling on the slave node, connection of which is checked.

11. The method according to claim 10, wherein:
upon transitioning to the scheduling communication state, a predetermined broadcasting timer is driven; and
when the broadcasting timer expires, the scheduling communication state is transitioned to the broadcasting state and the broadcasting procedure is performed.

12. The method according to claim 10, wherein, upon detection of change in a vehicle power condition in the scheduling communication state, the scheduling communication state is transitioned to the broadcasting state and the broadcasting procedure is performed.

13. The method according to claim 10, wherein, upon detection of a slave node with which communication is not possible in the scheduling communication state, the scheduling communication state is transitioned to the broadcasting state and the broadcasting procedure is performed.

14. The method according to claim 10, further comprising re-configuring a LIN scheduling table using the slave node, connection of which is checked via the broadcasting procedure,
wherein the message scheduling is performed using the re-configured LIN scheduling table.

15. The method according to claim 10, wherein, upon reception of a broadcasting request message from an external device in the scheduling communication state, the scheduling communication state is transitioned to the broadcasting state and the broadcasting procedure is performed.

16. A non-transitory computer readable recording medium having recorded thereon a program for executing the method of claim 1.

17. An apparatus for controlling scheduling for local interconnection network (LIN), the apparatus comprising:
a LIN communication unit for performing a broadcasting procedure using a predetermined LIN scheduling table when the LIN bus is activated and checking a slave node connected to the LIN bus;
a LIN scheduling table update unit for re-configuring the LIN scheduling table using information about the slave node, connection of which is checked; and
a controller for performing message scheduling using the re-configured LIN scheduling table.

18. The apparatus according to claim 17, further comprising a scheduling update event detector for detecting a scheduling update event during the message scheduling, wherein the LIN scheduling table is re-configured according to detection of the scheduling update event.

19. The apparatus according to claim 18, wherein:
the scheduling update event is detected when communication with the salve node, connection of which is checked, is not possible; and
scheduling information about the slave node with which communication is not possible is deleted from the LIN scheduling table.

20. The apparatus according to claim 18, wherein the scheduling update event is detected when a vehicle power condition is changed.

21. The apparatus according to claim 17, wherein the LIN communication unit transmits a message header to all slave nodes connectable to the LIN bus and performs the broadcasting procedure for checking a connection state of the slave node according to whether a message response corresponding to the message header is received.

22. The apparatus according to claim 21, wherein the LIN communication unit repeatedly performs the broadcasting procedure a predetermined number of times.

23. The apparatus according to claim 22, wherein the broadcasting procedure is periodically performed during the message scheduling.

24. The apparatus according to claim 17, further comprising an external interface unit for communication with an external device, wherein the controller controls to perform the broadcasting procedure when a predetermined broadcasting request message is received from the external device during the message scheduling.
